(19) United States
(12) Patent Application Publication
(10) Pub. No.: US 2005/0111746 A1
(43) Pub. Date: May 26, 2005

(54) Progressive medical image volume navigation

(76) Inventors: Bharath SV Kumar, Bangalore (IN); Sudipta Mukhopadhyay, Bangalore (IN); Vishram Vinayak Nandedkar, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 10/724,314

(22) Filed: Nov. 26, 2003

(51) Int. Cl. G06K 9/36; G06K 9/46; G06K 9/00

(52) U.S. Cl. 382/248; 382/240; 382/128

(57) ABSTRACT

A method of processing medical image data includes receiving data indicative of a group of consecutive cross sectional images of a three dimensional volume being imaged. The group of consecutive cross sectional images has a first axial resolution in a z-axis direction and a first spatial resolution in x-axis and y-axis directions orthogonal to the z-axis. The method also includes transforming, such as by wavelet transforming, the group of consecutive cross sectional images in the z-axis direction to generate an axially transformed representation of the group, so that the axially transformed representation has a second axial resolution lower than the first axial resolution. The method may also include transforming the axially transformed representation in x-axis and y-axis directions to generate a spatially transformed representation. An apparatus includes processing modules for receiving data indicative of the group and transforming the group of consecutive cross sectional images in the z-axis direction, respectively.

### FIELD OF THE INVENTION

The present invention is generally related to data processing, and, more particularly, to data compression/decompression of 3D medical images for efficient transmission and viewing of the images.

### BACKGROUND OF THE INVENTION

Conventional medical imaging systems, such as computed tomography (CT), magnetic resonance imaging (MRI) and positron emission tomography (PET), produce three dimensional (3D) data indicative of a body portion imaged, typically in the form of two dimensional (2D) image “slices.” Each slice may represent a different cross section of the body portion, and each slice may slightly overlap adjacent slices. While providing important diagnostic information for radiologists, storing large amounts of image data requires considerable information storage capability. Furthermore, communication of such data for viewing at remote locations may require a relatively high bandwidth data link. Picture archival and communication systems (PACS) have been proposed to handle the large image data requirements in the medical industry, such as by providing full resolution and multi-resolution images over a high bandwidth Local Area Network (LAN) or in narrow bandwidth applications, such as over a wide area network (WAN). However, in narrow bandwidth applications, the data may need to be compressed to reduce transmission bandwidth requirements and increase transmission speed. Such compressed images are then decompressed upon receipt by a remote client computer.

Medical image scanners such as CT, MRI, or PET scanners are capable of providing increasingly thinner scan slices than such scanners were capable of producing in the past. For example, older technology scanners may have provided 180 scan slices for an imaged body portion, while scanners incorporating more recent technology may provide up to 1500 scan slices for the same imaged body portion. While thinner slices provide higher resolution than the relatively thicker scans of the past, the amount of image slices that a radiologist needs to review has increased up to eight fold. As a result of the increased demands for reviewing increasingly larger amounts of scan slices, radiological diagnosis times have correspondingly increased.

To make the diagnosis process more efficient, radiologists typically use two methods to review image scans: the radiologist may skip scan slices; or; the radiologist may request thicker, or “averaged,” slices having decreased resolution in a z-axis, or axial, direction, while having full resolution in spatial, or x-axis and y-axis directions, orthogonal to the axial direction. If a radiologist chooses the latter method, the scanner console needs to reprocess the image to generate thicker, averaged scan images. If the radiologist then desires a higher resolution than the reprocessed averaged slices, the scanner console needs to regenerate the scanned image slices at a requested resolution, or thickness. Accordingly, the scanned image slices may need to be regenerated and re-sent each time a radiologist desires a different axial resolution. Although 3D transformation of medical image data, such as by simultaneously wavelet transforming the images in the x-axis, y-axis, and z-axis directions, has been proposed to improve image viewing efficiency, such methods fail to provide averaged frames at full spatial resolution because the wavelet transform is performed for each level of decomposition in each 3D direction.

### BRIEF DESCRIPTION OF THE INVENTION

A method of processing medical image data is described herein as including receiving data indicative of a group of consecutive cross sectional images of a three dimensional volume being imaged, wherein each of the cross sectional images are perpendicular to a z-axis. The group of consecutive cross sectional images includes a first axial resolution in a z-axis direction and a first spatial resolution in x-axis and y-axis directions orthogonal to the z-axis. The method further includes transforming the group of consecutive cross sectional images in the z-axis direction to generate an axially transformed representation of the group, wherein the axially transformed representation has a second axial resolution lower than the first axial resolution.

An apparatus for processing medical image data is described herein as including a processor module configured to receive data indicative of a group of consecutive cross sectional images of a three dimensional volume being imaged. The apparatus further includes a processor module configured to compress the group of consecutive cross sectional images in the z-axis direction to generate an axially transformed representation of the group.

### BRIEF DESCRIPTION OF THE DRAWINGS

FIG. 1 shows a block diagram of an exemplary 3D medical image processing system embodying aspects of the present invention.

FIG. 2 shows a flow chart for an exemplary method for processing 3D medical image information.

FIG. 3 shows sub-band boundaries for an exemplary wavelet decomposition of a 3D volume.

FIG. 4A shows a block diagram of an exemplary entropy encoder for performing Huffman encoding.

FIG. 4B shows a block diagram of an exemplary entropy decoder 96 for performing Huffman decoding.

FIG. 5A shows an exemplary bit stream format for progressive encoding of image data for multi resolution in a z-axis direction.

FIG. 5B shows an exemplary bit stream format for progressive encoding of image data for multi resolution in a z-axis direction and multi resolution in x-axis and y-axis directions.

FIG. 6 is a flow chart for a method of viewing images at multiple resolutions.

In certain situations, for reasons of computational efficiency or ease of maintenance, the ordering of the blocks of the illustrated flow charts may be rearranged by one skilled in the art. While the present invention will be described with reference to the details of the embodiments of the invention shown in the drawing, these details are not intended to limit the scope of the invention.

### DETAILED DESCRIPTION OF THE INVENTION

The inventors of the present invention have innovatively realized that by transforming, such as by wavelet transforming, a sub-volume, or set of several individual slices, in a z-axis direction, while preserving full spatial resolution in x-axis and y-axis directions, an initially desired averaged thick slab representation of the slices may be generated. As a result, the images may be efficiently decompressed for viewing by a radiologist to first allow quick navigation through the data in a relatively low resolution mode and then allow selection of relatively high resolution viewing areas in an intuitive browsing technique in concert with the manner in which the radiologist typically examines such data. As used herein, the term compression means a method of reducing the amount of data required to represent an image or series of images and may include methods such as wavelet transformation; Discrete Cosine Transform (DCT) transformation, predictive encoding transformations, including, for example, Differential Pulse Code Modulation (DPCM) encoding; and entropy encoding, including, for example, arithmetic encoding, run-length encoding (RLE), and Huffman encoding. In addition to compression, progressive display of the image, as understood in the art, may be used to mask a transmission delay by first providing a relatively low, or coarse, resolution for browsing, while loading relatively high, or fine, resolution data as the radiologist navigates through the thick slab to find an area of interest.

Further compression may be performed on the thick slab compressed in the z-axis direction by transforming the image in the x-axis and y-axis directions. In yet another aspect, the compressed data may be further encoded to take advantage of image correlation, especially in the z-axis direction, providing further compression gains. For example, adjacent scan images may have relatively little slice to slice variation, or relatively high correlation, allowing higher compression gains. Accordingly, data transmission times can be decreased compared to 2D compression schemes, in particular, for clients having lower bandwidth communication links, such as WAN links. Compression of a data set in the z-axis direction advantageously generates an averaged thick slab desired for low resolution viewing by radiologists and also allows improved compression ratios because of correlation of images in the z-axis direction. In addition, a process of wavelet transforming in z-axis direction has the affect of generating weighted averaging of data to provide an approximate version of the signal. Accordingly, the wavelet transform advantageously suppresses noise and, therefore, improves image quality.

Unlike prior image compression methods (such as simultaneous 3D wavelet transforms) that may require decoding of all the frames, and then averaging the frames to produce a thick slab, in the present invention the thick slab, may be generated while decompressing the compressed information, thus requiring less computational overhead and higher speed viewing than conventional methods. Advantageously, the thick slab generated in the process of decompressing becomes an averaged representation of the composite slices and allows convenient progressive decoding of the images, especially in the axial direction. By first providing a thick slab representation, less data than would normally be required with conventional methods is needed for decompression if a viewer is satisfied with the initial thick slab representation. In addition, a radiologist may choose a slab thickness “on the fly” by decompressing more data to select finer slab thicknesses, rather than commanding the scanner to regenerate the image at a different slab thickness. Furthermore, all decompression information, from spatially compressed thick slab representation to fully reconstructed (loss-less) images can be encoded in the same bit stream, reducing requirements for local storage space. In addition, lossy compression techniques, such as quantization techniques, may be used to compress the data for encoding in the bit stream.

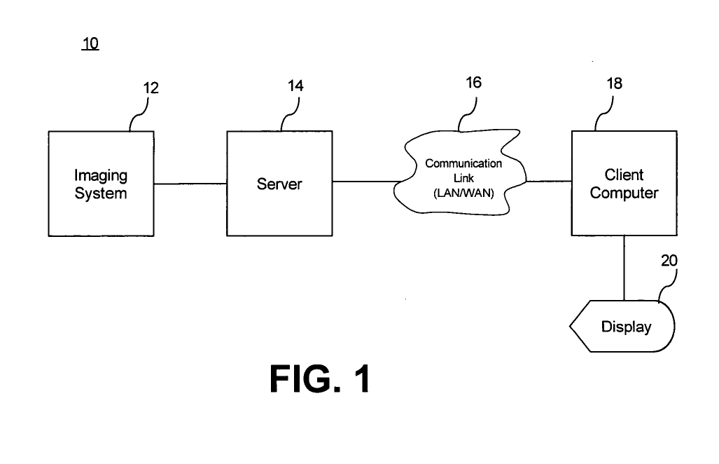

FIG. 1 shows an exemplary block diagram of a 3D medical image processing system 10 embodying aspects of the present invention. Generally, the system 10 includes an imaging system 12, such as CT, MRI, or PET scanning system and a server 14 for storing and compressing imaging data from the imaging system 12 and transmitting compressed information over a communication link, such as a LAN/WAN 16. The system 10 also includes a client computer 18 for receiving the compressed information from the server 14 and decompressing the compressed information, and a display 20 for displaying the decompressed information. A radiologist operating the client 18 may request images from the server 14 and the server 14 may respond by serving compressed images provided, for example, to the client 18 in a progressively encoded data stream. The compression and decompression aspects of the invention are described in greater detail below.

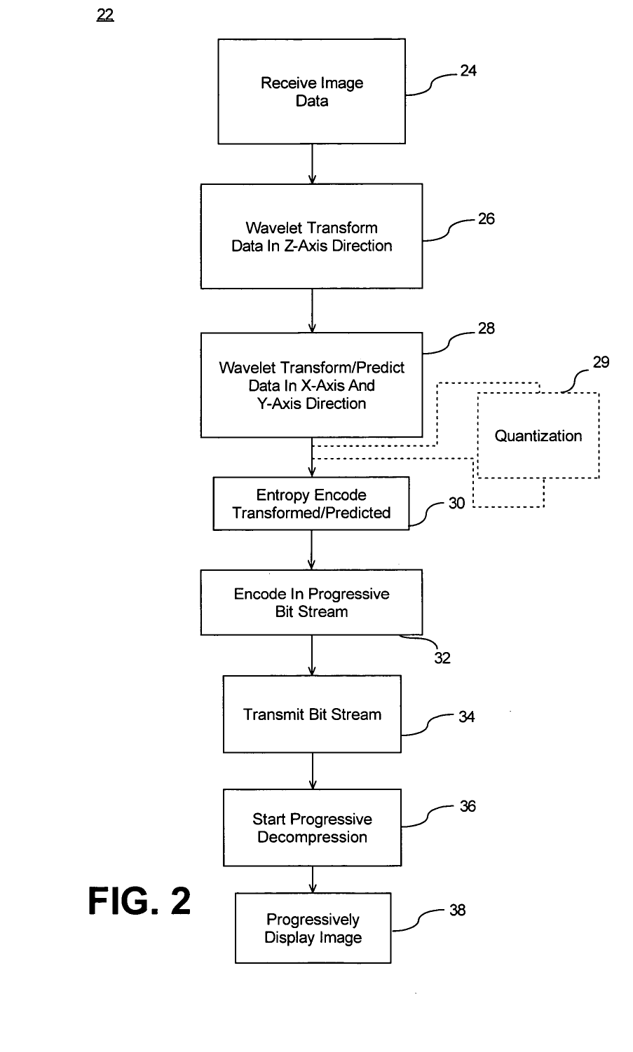

FIG. 2 shows a flow chart 22 of an exemplary method for processing 3D medical image information. Initially, data indicative of images are received 24, for example, at the server 14. The data may be indicative of respective consecutive cross sections of a 3D volume, such as portion of a human body scanned by a medical imaging system 12, the cross section being generally perpendicular to an axial, or z-axis direction. After receipt, the data may be compressed in the z-axis direction 26, such as by performing wavelet decomposition in one dimension, in the z-axis direction. As understood in the art, a wavelet decomposition of an image produces a reduced resolution version of the image and information to allow recreation of the original image at full resolution. Examples of 3D medical image compression/decompression schemes using wavelet transforms can be found in Bilgin, A., Zwieg, G., Marcellin, M. W., Three-dimensional image compression with integer wavelet transforms, Applied Optics, Vol. 39, no. 11 (Apr. 10, 2000), pp. 1799-1814, incorporated herein by reference. In an aspect of the invention, the data may be divided into subsets of data, or sub-volumes, including data indicative of several image slices included in the subset. Each sub-volume may include, for example, information representing 2, 4, 8, or 16 adjacent slices. It should be understood, however, that any number of slices may be included in a sub-volume. A wavelet decomposition may be performed separately on each of the sub-volumes to create a first compressed representation of a “thick slab”. Advantageously, the wavelet decomposition provides a thick slab representing an average of all the composite slices of a sub-volume in the z-axis direction.

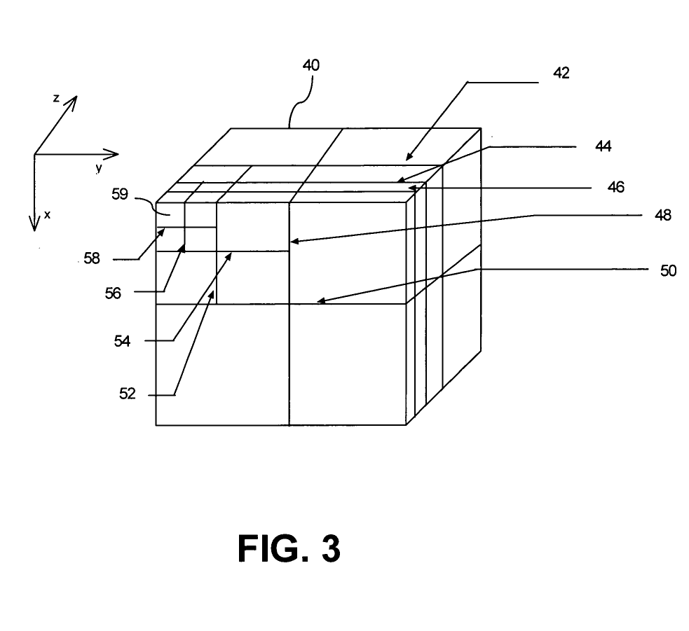

FIG. 3 shows sub-band boundaries for an exemplary wavelet decomposition of a 3D volume. In the wavelet decomposition scheme depicted in FIG. 3, multiple levels of decomposition are performed. FIG. 3 shows sub-band boundaries for an exemplary wavelet decomposition of a 3D volume, such as a thick slab 40, wherein the sub-band boundaries are indicative of levels of decomposition. For example, for thick slab 40 comprising eight slices, three levels of decomposition in the z-axis direction, indicated by sub-band boundaries 42, 44, and 46, may be performed to form the first compressed representation of the slab 40. If each of the slices has a thickness of 0.625 millimeter (mm) (with no overlap between the consecutive slices in the thick slab), after one level of wavelet decomposition in the z-axis direction, four reduced resolution representations are generated, each representation corresponding to two full resolution slices and representing an averaged slice of thickness 1.25 mm (2 slices×0.625 mm per slice). After a second level of wavelet decomposition in the z-axis direction, two reduced resolution representations, representing a thickness of 2.5 mm (4 slices×0.625 mm per slice), are generated. After three levels of decomposition, one reduced resolution representation is generated, representing a total thick slab of thickness 5 mm (8 slices×0.625 mm per slice). Such a compression scheme preserves the resolution of the thick slab 40 in a spatial, or x-y axis, direction orthogonal to the z-axis. Advantageously, only z-axis wavelet decomposition coefficients corresponding to the spatial dimensions of the decomposed slab are required to reconstruct a highest level of decomposition corresponding to a lowest resolution version, of the thick slab 40 in the z-axis direction.

Returning to the flow chart of FIG. 2, after wavelet transform in the z-axis direction 26, the resulting first transformed representation of each of the thick slabs 40 may be further transformed in an x-axis direction and a y-axis direction to create a second transformed representation. Accordingly, the resolution of the thick slab 40 in a spatial, or x-y direction, may be reduced to provide more efficient transmission in a progressive display scheme. For example, a wavelet decomposition may be performed by alternately decomposing in the x-axis direction and the y-axis direction to generate progressively reduced spatial resolution representations, such as indicated by spatial sub-band boundaries 48, 50, 52, 54, 56, 58 in FIG. 3. In another aspect, a DPCM transformation may be used to de-correlate the first transformed representation in the x-axis direction and a y-axis direction to create a prediction residual second transformed representation. After transforming in the x-axis direction and a y-axis direction, the second transformed representation may be optionally quantized 29 using a lossy compression scheme, as would be understood by a skilled artisan.

The representations may be compressed by performing an entropy encoding step 30 to take advantage of image correlation among the slices comprising the thick slab 40. For example, entropy encoding, such as arithmetic encoding or Huffman encoding, may be performed after transformation of the sub-volume, obtained for example, after wavelet transformation or DPCM transformation, to create entropy compressed information. In one exemplary form of the invention, a Huffman encoding scheme may be applied to the transformed or prediction residual representations.

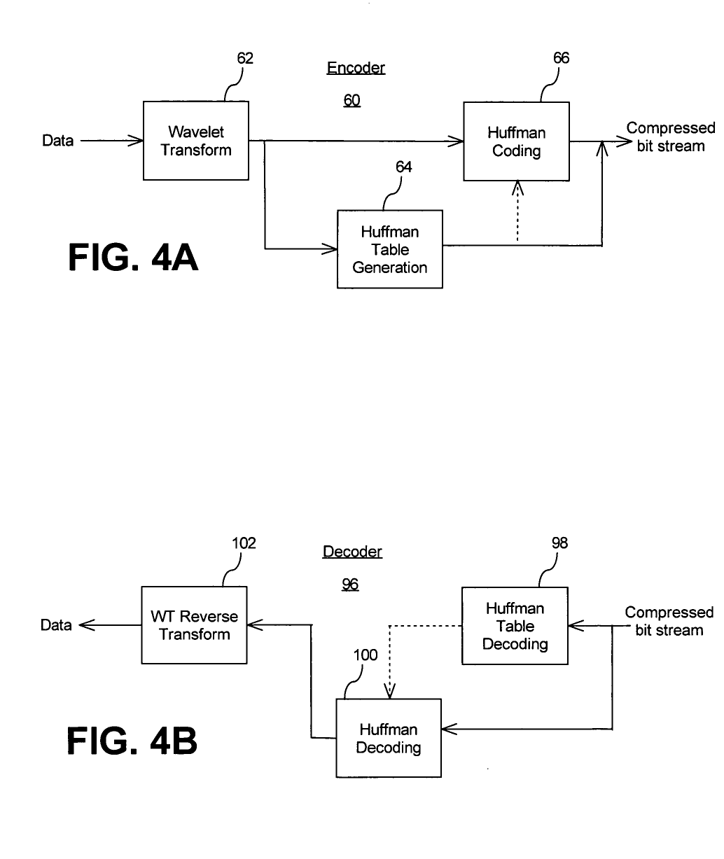

FIG. 4A shows an exemplary block diagram of an entropy encoder 60 for performing Huffman encoding 60 on wavelet transformed image data. After performing a wavelet transform 62 to generate transformed image data (such as the second transformed representation as described above), Huffman coding 66 may be performed on the transformed image data to generated compressed image data. In addition, a Huffman coding table may be generated 64 and used for Huffman coding 66. Entries in the Huffman table may be dynamically updated depending on data correlation statistics to provide adaptive encoding. In an aspect of the invention, the Huffman coding table may also be included in a compressed image bit stream transmitted to a client to allow more efficient Huffman decoding at the client 18. The above described compression schemes may be performed after receiving raw image data, for example, from an imagining system 12, and stored as compressed data to reduce memory storage requirements in the server 14. In another aspect, the raw image data may be stored without compression, and compression of the data may be performed “on the fly” when a request for the data is received.

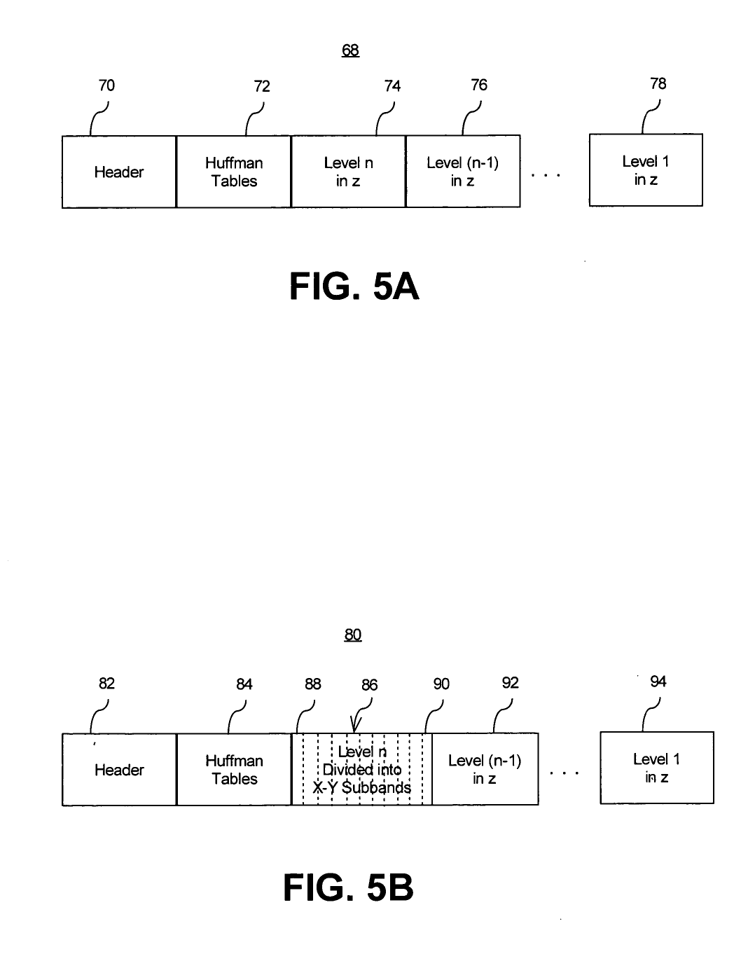

After entropy encoding 30, the resulting entropy compressed information may be encoded in a bit stream to allow, for example, progressive decoding of the thick slab at the client 18. FIG. 5A shows an exemplary bit stream 68 for progressive encoding of an image, such as a thick slab, wavelet transformed in the z-axis direction, and DPCM transformed in the x-y direction.

The bit stream 68 includes a header 70, for example, including a version number of the resolution scheme, the type of forward transform, the number of levels of wavelet decomposition, the row and column values, and number of slices used in each sub-volume, and the compressed sizes of the wavelet sub-bands. The header 70 information may be followed by an entropy decoding table, such as a Huffman code table 72, for decoding an entropy code applied to the image data. After the Huffman code table 72, compressed data may be provided, such as in a progressive encoding format. In an aspect of the invention, the lowest resolution, or highest decomposition level n, (for example, corresponding to the third z-axis decomposition result indicated by sub-band 46 in FIG. 3) compressed data is provided in the first data portion 74 of the bit stream. In addition, DPCM data, such as DPCM coefficients for 2D compression in the x-axis and y-axis direction at the current level n is encoded in first data portion 74. Following the level n data, the next higher resolution, or next lower decomposition level, level n−1, compressed data is provided in a second data portion 76 of the bit stream. Second data portion 76 may also include DPCM data for 2D compression in the x-axis and y-axis direction for level n-1. The bit stream may be progressively encoded as described above until arriving at a last data portion 78, encoded with compressed data corresponding to the first decomposition level 1. Portion 78 may also include DPCM data for the level 1.

FIG. 5B shows another exemplary bit stream 80 configuration for progressive encoding of an image with wavelet decompression in the z-axis direction, followed by wavelet decomposition in the x-axis and y-axis dimensions. The bit stream 80 includes a header 82 followed by an entropy decoding table, such as a Huffman code table 84. After the Huffman code table 84, compressed data may be provided in a progressive encoding format. The first data portion 86 of the bit stream is reserved for the lowest resolution, or highest decomposition, level n, compressed data, for example, the compressed data corresponding to the third z-axis decomposition result indicated by sub-band 46 in FIG. 3. In aspect of the invention, the first data portion 86 is further progressively encoded with transformed x-axis and y-axis data, representing further compression of the level n data transformed in a z-axis direction. In addition, subsequent portions 92, 94 may be progressively encoded with corresponding transformed x-axis and y-axis data.

For example, the first data portion 86 may be progressively divided into sub portions corresponding to levels of wavelet decomposition in the x-axis and y-axis directions. According to a progressive encoding scheme, compressed data for the lowest resolution, or highest decomposition level in the x-axis and y-axis direction (for example, corresponding to a 3rd level of x-axis and y-axis decomposition indicated by decomposition level 58 in FIG. 3) is stored in the first sub-portion 88. Progressively higher resolution compressed data may be stored in consecutive sub-portions so that the last sub-portion 90 contains compressed data for the highest resolution, lowest level of decomposition in the x-axis and y-axis direction. After the first data portion 86, the next higher resolution, or next lower decomposition level, level n−1, z-axis compressed data is provided in second data portion 92 of the bit stream. Level n−1 may further be divided into x-y sub-bands (not shown) in the same manner as level n. The second data portion 92 is followed by progressively higher resolution levels so that the last data portion 94 of the bit stream is encoded with compressed data corresponding to the first decomposition level, level 1.

Returning to FIG. 2, after the compressed data is encoded, the progressive bit stream may be transmitted 34, for example, to a client 18 at the client's request. As the bit stream is received at the client 18, the compressed data encoded in the bit stream may be progressively decompressed 36 to progressively display 38 increasingly finer resolution representation of a desired image. For example, the bit stream may be chronologically decompressed in order of arrival of information at the client 18, so that the comparatively lower resolution information stored in the first data portions of the bit stream are available to create an initial comparatively low resolution image, followed by increasingly higher resolution information contained in later received data portions of the bit stream. In an aspect of the invention the step of decompression 36 may include entropy decoding of the received compressed data. FIG. 4B shows an exemplary block diagram of an entropy decoder 96 for performing entropy decoding such as Huffman decoding 100 prior to wavelet reverse transforming 102 the image data. Huffman decoding 100 may be performed by using a Huffman decoding table 98 included, for example, in the received compressed bit stream. It will be appreciated that Huffman coding/decoding is just an example of entropy encoding/decoding and should not be construed as a limitation on the present invention.

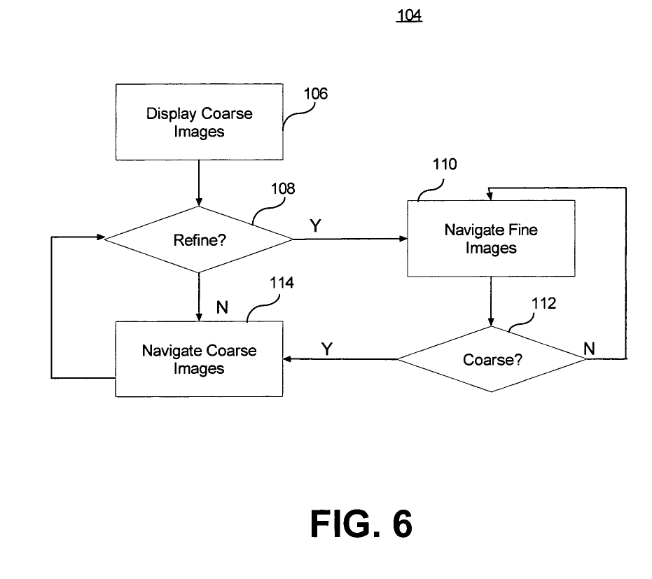

FIG. 6 is a flow chart 104 for navigating decompressed images displayed during the step of progressive display 38 depicted in FIG. 2. In operation, a viewer, such as a radiologist, at a client 18 sends a request to the server 14 to view a desired image. For example, the radiologist may request to view a specific thick slab from among a set of thick slab images. The server 14 responds by sending the requested thick slab image in a compressed, progressively encoded bit stream. Upon receipt, the client 18 decompresses the image and displays 106 a coarse, or comparatively low resolution, version of the image corresponding to the low resolution data encoded at the beginning of the bit stream. For example, the radiologist may first receive a lowest resolution image, or the second compressed representation, corresponding to the sub-band level 59 indicated by sub-band boundary 58 shown in FIG. 3.

If the radiologist desires to refine, or acquire a comparatively higher resolution of the image 108, then the radiologist may request to navigate finer, or comparatively higher resolution images 110 until arriving at a desired resolution. As the radiologist requests a comparatively higher resolution image, increasingly more data portions of the bit stream are decoded to provide progressively higher resolution versions of the image. In one aspect of the invention, initial requests for increased resolution of the display will invoke reconstruction of the image data in x-axis and y-axis direction corresponding to the chronological order in which the transformed data is encoded in the bit stream. After all the x-axis and y-axis transformation information is reconstructed, a full spatial resolution version, or the first transformed representation, comprising an averaged thick slab view of the sub-volume, is provided for display. Then, as more resolution of the sub-volume is requested, z-axis transformed data in the bit stream is progressively reconstructed to provide increasingly higher resolution, or progressively “de-averaged,” thick slab views in an axial direction. Increasing axial resolution may be progressively displayed until reaching the full resolution of sub-volume. For example, to view one individual slice comprising a sub-volume, a radiologist selects the sub-volume corresponding to the desired slice and that sub-volume is fully decoded. If a sub-volume comprises, for example, eight individual slices, the sub-volume is completely decoded to allow viewing of any one of the eight individual slices comprising the thick slab.

Accordingly, a fully decompressed image may be stored locally at the client 18 once the entire reconstruction bit stream has been received, or compressed image information may be continually streamed to the client 18 to provide a desired resolution of the image as the radiologist requests different resolutions of the image. If, having reached a desired higher level of resolution, the radiologist desires to view the image at a relatively lower, or coarse, resolution 112, (for example, for navigating through the data in a low resolution mode at a faster rate because less information is required to recreate an image at a comparatively lower resolution) the radiologist may elect to return to viewing a lower resolution display 114. Accordingly, the desired level of resolution may be requested from the server 14 and the appropriate compressed information for the desired resolution may be extracted from the bit stream. If the information in the bit stream has been stored locally at the client 18, the desired resolution image may be extracted from the locally stored compressed information. If the radiologist then desires to view comparatively higher resolution images, the images can be further refined, such as by extracting the image data from a received bit stream, or extracting the image data form compressed data previously stored locally. The above described procedure advantageously provides conservation of transmission bandwidth and reduces processing requirements, especially if the radiologist does not require comparatively high resolution images to navigate image data to locate an image region which the radiologist desires to view at comparatively high resolution. Once a desired level of resolution of an image is displayed, no further compressed image information need be provided, nor does additional decompression need to be performed. Importantly, this technique allows a radiologist to select an appropriate amount of information required for diagnosis, without having to unnecessarily cull though a multitude of high resolution images before finding an area of interest required to make the diagnosis. Advantageously, the productivity of the radiologist may be increased compared to conventional methods.

The present invention can be embodied in the form of computer-implemented processes and apparatus for practicing those processes. The present invention can also be embodied in the form of computer program code containing computer-readable instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose computer, the computer program code segments configure the computer to create specific logic circuits or processing modules.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

1. A method of processing medical image data comprising:
receiving data indicative of a group of consecutive cross sectional images of a three dimensional volume being imaged, each of the cross sectional images being perpendicular to a z-axis, the group of consecutive cross sectional images having a first axial resolution in a z-axis direction and having a first spatial resolution in x-axis and y-axis directions orthogonal to the z-axis; and
transforming the group of consecutive cross sectional images in the z-axis direction to generate an axially transformed representation of the group, the axially transformed representation having a second axial resolution lower than the first axial resolution.

2. The method of claim 1, further comprising generating reconstruction data to allow reconstruction of the group from the axially transformed representation.

3. The method of claim 2, further comprising:
providing the axially transformed representation to a viewer; and
progressively providing the reconstruction data to allow reconstruction of the group at the first axial resolution.

4. The method of claim 1, wherein transforming the group of consecutive cross sectional images further comprises performing a wavelet transform on the data.

5. The method of claim 1, further comprising performing entropy encoding of the axially transformed representation.

6. The method of claim 1, further comprising transforming the axially transformed representation in x-axis and y-axis directions to generate a spatially transformed representation of the axially transformed representation, the spatially transformed representation having a second spatial resolution lower than the first spatial resolution.

7. The method of claim 6, wherein transforming the axially transformed representation further comprises performing a compression technique selected from the group consisting of a wavelet transform and a differential pulse code modulation prediction.

8. The method of claim 6, further comprising:
providing the spatially transformed representation to a viewer; and
progressively providing information to allow reconstruction of the spatially transformed representation.

9. The method of claim 6, further comprising performing entropy encoding of the spatially transformed representation.

10. A method of processing medical image data comprising:
providing a first representation of a group of cross sectional images transformed in an axial direction, the first representation having a first axial resolution and a first spatial resolution to allow selection of the group of cross sectional images; and
progressively providing a second representation of the cross sectional images, the second representation having a second axial resolution comparatively greater than the first axial resolution to provide comparatively greater axial detail than an axial detail of the first representation.

11. The method of claim 10, further comprising providing a third representation by transforming the first representation in a spatial direction, the third representation having a transformed spatial resolution comparatively less than the first spatial resolution.

12. A method of processing medical image data comprising:
receiving data indicative of images representing consecutive cross sections of a three dimensional volume being imaged, the cross sections being perpendicular to a z-axis;
transforming, in one dimension, a plurality of the images in a z-axis direction to generate a first transformed representation of the three dimensional volume; and
transforming, in two dimensions, the first transformed representation in an x-axis direction orthogonal to the z-axis direction and a y-axis direction orthogonal to the z-axis to generate a second transformed representation of the three dimensional volume.

13. The method of claim 12, wherein transforming in one dimension further comprises performing at least one level of wavelet decomposition.

14. The method of claim 12, wherein transforming in two dimensions further comprises performing at least one level of wavelet decomposition.

15. The method of claim 12, further comprising performing entropy encoding of at least one of the group consisting of the first transformed representation and the second transformed representation.

16. The method of claim 15, wherein performing entropy encoding further comprises Huffman encoding.

17. The method of claim 16, wherein Huffman encoding further comprises creating a Huffman look up table.

18. The method of claim 12, further comprising generating a data stream comprising information for progressively reconstructing the second transformed representation, followed by information for progressively reconstructing the first transformed representation.

19. The method of claim 18, wherein the data stream further comprises an entropy decoding table for decoding entropy encoded data.

20. The method of claim 18, further comprising progressively extracting at least a portion of the information from the data stream according to a desired level of viewing detail of the three dimensional volume.

21. The method of claim 18, further comprising reconstructing the second transformed representation, then reconstructing the first transformed representation to achieve a desired level of viewing detail of the three dimensional volume.

22. An apparatus for processing medical image data comprising:
a processor module configured to receive data indicative of a group of consecutive cross sectional images of a three dimensional volume being imaged, each of the cross sectional images being perpendicular to a z-axis, the group of consecutive cross sectional images having a first axial resolution in a z-axis direction and having a first spatial resolution in x-axis and y-axis directions orthogonal to the z-axis; and
a processor module configured to compress the group of consecutive cross sectional images in the z-axis direction to generate an axially transformed representation of the group, the axially transformed representation having a second axial resolution lower than the first axial resolution.
